(19) United States
(12) Patent Application Publication
(10) Pub. No.: US 2014/0268532 A1
(43) Pub. Date: Sep. 18, 2014

(54) FLEXIBLE ELECTRONIC DISPLAY AND STAND

(71) Applicant: BFAM CORP., Kaysville, UT (US)

(72) Inventors: Loran Alan Nicol, Layton, UT (US); Todd Alton Benner, Manchester, MD (US); Lance Morrison Bastian, Lewis Center, OH (US)

(21) Appl. No.: 14/207,278

(22) Filed: Mar. 12, 2014

Related U.S. Application Data
(60) Provisional application No. 61/792,263, filed on Mar. 15, 2013.

(51) Int. Cl. G06F 1/16; G09F 9/30

(52) U.S. Cl. CPC G06F 1/1652; G09F 9/301
USPC 361/679.26; 361/749

(57) ABSTRACT

An electronic display assembly may comprise a flexible electronic display screen that may be rolled onto a reel in a retracted configuration and extend from the reel in an extended configuration. Additionally, some electronic display stands are capable of connecting to and supporting a flexible electronic display screen in an extended configuration.

### RELATED APPLICATIONS

This application claims priority to U.S. Provisional Application No. 61/792,263 filed on Mar. 15, 2013 and titled “FLEXIBLE LED, OLED, OR LCD DISPLAY AND STAND,” which is hereby incorporated by reference in its entirety.

### TECHNICAL FIELD

The present disclosure is directed to flexible electronic displays and stands for supporting flexible electronic displays.

### SUMMARY

Disclosed herein are embodiments of a flexible electronic display that may be used to display static or dynamic images. In certain embodiments, the flexible electronic display may be rolled up onto a reel, bobbin, spool, or the like. The flexible electronic display may be connected electrically to the reel, such that data and/or power may be transferred to the flexible electronic display via the reel. In certain embodiments, the rolled up electronic display may be stored in a container such as drum, pipe, box, or the like. In certain embodiments, the flexible electronic display may comprise a computing device suitable for storing images and controlling the display elements (e.g., light emitting diodes (LEDs), organic light emitting diodes (OLEDs), Liquid Crystal Display (LCD) elements, or electronic paper (e-paper) pixels) to display an image. In some embodiments, the flexible electronic display comprises a human-machine interface to receive user input. In certain embodiments, the flexible electronic display may comprise a power source, such as a battery. In certain embodiments, the flexible electronic display receives power from an external source. In certain embodiments, the flexible electronic display may connect to an external computer device to receive image data and/or instructions. In certain embodiments, the flexible electronic display comprises an interface for receiving a removable data storage device, such as a USB flash drive. In certain embodiments, the flexible electronic display may synchronize with other electronic displays to display the same image or a complimentary image.

Disclosed herein are embodiments of an electronic display stand for holding a flexible electronic display. In certain embodiments, the electronic display stand may comprise a power source, such as a battery. In certain embodiments, the electronic display stand may comprise a computing device suitable for storing images and controlling the flexible electronic display to display an image. In some embodiments, the electronic display stand also comprises a human-machine interface to receive user input. In certain embodiments, the electronic display stand receives a reel onto which a flexible electronic display rolled. In certain embodiments, the electronic display stand comprises a docking connector for connecting electrically to the flexible electronic display. In certain embodiments, the electronic display stand comprises a docking station for holding the flexible electronic display and connecting electrically to the flexible electronic display. In certain embodiments, the electronic display stand has feet to enhance its stability. In certain embodiments, the electronic display stand has handles and/or wheels for transportation. In certain embodiments, the electronic display stand has one or more extendable masts for supporting the flexible electronic display in an extended (unrolled) arrangement. In certain embodiments, the electronic display stand may deploy the flexible electronic display between a rolled arrangement and an unrolled arrangement in an automated or semi-automated fashion. In certain embodiments, the electronic display stand can simultaneously hold and/or support more than one flexible electronic display.

Disclosed herein are embodiments of a flexible electronic display system comprising a flexible electronic display and a display stand for holding the flexible electronic display. In certain embodiments, the flexible electronic display system may comprise a power source, such as a battery, that is located either in the flexible electronic display or in the display stand. In certain embodiments, the flexible electronic display system may comprise handles and/or wheels for transporting the flexible electronic display system. In certain embodiments, the flexible electronic display system is capable of deploying and/or retracting in automated or semi-automated fashion. In certain embodiments, the flexible electronic display system is capable of synchronizing with other display systems, such as one or more other flexible electronic display systems, to display the same image or a complimentary image. In certain embodiments, the flexible electronic display system may comprise a computing device suitable for storing images and controlling the flexible electronic display to display an image. In some embodiments, the flexible electronic display system also comprises a human-machine interface to receive user input.

### BRIEF DESCRIPTION OF THE DRAWINGS

FIG. 1 illustrates a flexible electronic display according to certain embodiments of the present disclosure.

FIG. 2 illustrates a display stand for use with a flexible electronic display according to certain embodiments of the present disclosure.

FIG. 3 illustrates a flexible electronic display system according to certain embodiments of the present disclosure.

FIG. 4 illustrates a flexible light emitting diode (LED) display according to certain embodiments of the present disclosure.

FIG. 5 illustrates a computer device for controlling a flexible electronic display according to certain embodiments of the present disclosure.

FIG. 6A illustrates a stand for use with a flexible electronic display according to one embodiment of the present disclosure.

FIG. 6B illustrates a stand for use with a flexible electronic display according to another embodiment of the present disclosure.

### DETAILED DESCRIPTION OF PREFERRED EMBODIMENTS

Displays are used often at tradeshows to attract attention to one's products or services. Often displays comprising an image printed onto a fabric or other flexible material are used as they are easy to transport.

Recent developments in display technology have resulted in flexible electronic displays. Rather than fabricating the diodes on a rigid substrate, such as glass, the electronic display elements are fabricated onto a flexible substrate. One example of flexible electronic display technology is an organic light emitting diode (OLED) fabricated on a flexible substrate. In some embodiments, the flexible substrate may comprise a poly ethylene terephthalate (PET) substrate. Other examples of flexible electronic display technologies include liquid crystal displays (LCDs) and electronic paper (e-paper) displays. Flexible electronic displays may be folded or rolled up onto a scroll or bobbin. These rolled up flexible electronic displays are easy to transport and also able to be seen from far away when unfurled. Although the present disclosure primarily refers to light emitting diode (LED) or OLED displays, those skilled in the art will recognize that any flexible electronic display may be used in the disclosed invention, including LCDs and e-paper displays.

Disclosed herein are embodiments of a flexible electronic display that may be used to display static or dynamic images. Generally, the flexible electronic display comprises a matrix of electronic display elements (e.g., LEDs, LCD pixels, or e-paper pixels) placed on a flexible medium. In some embodiments, the flexible electronic display comprises an OLED (organic light-emitting diode) display or an electrophoretic display (e.g., e-ink or e-paper) formed on a flexible substrate. In other embodiments, the flexible electronic display comprises a plurality of display elements (e.g., individual LEDs) arranged onto a flexible backing. The flexible backing may be a woven material, such as a fabric, a pliable material, such as a plastic, or a series rigid (or semi-rigid) slats that are linked together in a hinged manner, similar to the linkage of a roll-up window blind. Those skilled in the art will recognize considerable variation within the scope of the present disclosure regarding how electronic display elements may be attached to a flexible backing to form a flexible electronic display. In some embodiments, the flexible electronic display comprises a backing of soft material so that the display side isn't scratched or damaged when rolled up.

FIG. 1 illustrates embodiments of a flexible electronic display 100 capable of displaying static or dynamic images. The flexible electronic display 100 comprises a display screen 102, a reel 104, a slat 106, and a handle 108.

The display screen 102 may comprise any suitable flexible electronic display screen. For example, the display screen 102 may comprise a flexible LED screen (e.g., a flexible OLED display), a flexible electrophoretic display (e.g., e-ink or e-paper), a flexible matrix of individual display elements (e.g., individual LEDs arranged onto a flexible backing), or the like. In some embodiments, the display screen 102 is connected electrically to the reel 104 and receives data signals and/or power from (or through) the reel 104. In some embodiments, the display screen 102 comprises a connector that receives data signals and/or power. The display screen 102 receives data signals comprising images and is configured to display said images. The received images may be static images, dynamic images, or a combination of both static and dynamic images.

In certain embodiments, the display screen 102 may be rolled up onto the reel 104. The reel 104 may comprise any suitable reel, bobbin, spool, or the like. The reel 104 may be of a sufficiently large diameter to prevent undue stress on the display screen 102 when rolled up. The reel 104 may also be hollow to reduce weight. In some embodiments, an outer surface of the reel 104 that comes into contact with the rolled up display screen 102 may be formed of a soft material so that the display screen 102 is not scratched or otherwise damaged when rolled onto the reel 104. In some embodiments, the interior of the reel 104 may be used to store objects. For example, the interior of the reel 104 may be used to store electronics for using the display such as computing devices, cables, data storage devices, power storage devices, power adapters/conditioners, or any other accessory for use with the flexible electronic display 100.

In some embodiments, the reel 104 is connected electrically to the display screen 102, such that data and/or power may be transferred to the display screen 102 via the reel 104. In some embodiments, the reel 104 comprises a power source, such as a battery, capacitor, generator, or the like. In some embodiments the reel 104 comprises a power adaptor configured to receive power from a source external to the flexible display 100 and to convert the received power into a voltage, amperage, and/or waveform suitable for use by the display screen 102.

In certain embodiments, the rolled up flexible electronic display 100 may be stored in a storage container such as drum, pipe, box, or the like. The reel 104 may comprise an attachment mechanism configured to selectively couple with the storage container.

The slat 106 and handle 108 allow a user to extend the display screen 102 from a retracted (e.g., rolled up) configuration to an extended configuration. A user may pull on the handle 108 to extend the display screen 102. The slat 106 may be configured to attach to a hook, stand, mast, mount, or other suitable support element to maintain the display screen 102 in the extended position. In some embodiments, the slat 106 may comprise electronic components, such as a computer device, a power source, an input device (e.g., buttons and/or keys), an antenna, or the like, that are used in conjunction with the display screen 102 to display images. In some embodiments, the slat 106 may comprise speakers to provide audible output.

In certain embodiments, the flexible electronic display 100 may comprise a computing device suitable for storing images and/or controlling the display screen 102 to display an image. The computing device may be located in the reel 104, the slat 106 or any other suitable location on the flexible electronic display 100. The computing device may comprise circuitry, controllers, and/or other computer hardware configured to control the displaying of images on the display screen 102. The computing device may comprise a data storage medium for storing data representative of images to be displayed on the display screen 102. In certain embodiments, the flexible electronic display 100 comprises an interface for receiving a removable data storage device, such as a USB flash drive or memory card. The flexible electronic display 100 may retrieve images stored in the removable data storage device for displaying on the display screen 102.

In some embodiments, the flexible electronic display 100 comprises a human-machine interface (HMI) to receive input from, and provide output to, a user. The HMI may comprise a plurality of buttons and/or keys (e.g., a keyboard), a touch-panel, a voice-recognition system, and/or any other suitable means for receiving user input. An HMI may generate an output capable of being perceived by a user (e.g., a visual and/or audible output). In some embodiments, the HMI may comprise a display (e.g., a display that is smaller than the entire flexible electronic display) upon which a user interface (e.g., a graphical user interface) is presented to a user. For example, the HMI may comprise a small LED and/or LCD display and a plurality of buttons allowing a user to select and display a particular file stored in the flexible electronic display 100 or in an external memory device. In some embodiments, the HMI may output a user interface (e.g., a graphical user interface) on the display screen 102. In some embodiments, the HMI may comprise one or more speakers for providing audible output. In some embodiments, the HMI is a remote control interface so that a user can control the flexible LED display via a dedicated remote control or via an external device. For example, the remote control interface may be an application running on a portable electronic device (e.g., a laptop computer, a tablet computer, a personal data assistant (PDA), or a smartphone).

In certain embodiments, the flexible electronic display 100 may connect to an external computer device to receive image data and/or instructions. The flexible electronic display 100 may connect to the external computer device via a physical port located in, e.g., the reel 104 or the slat 106, or it may connect via a wireless interface (e.g., WI-FI® or BLUETOOTH® adapter). In certain embodiments, the flexible electronic display 100 may synchronize with other electronic displays to display the same image or a complimentary image. For example, the flexible electronic display 100 may communicate with a plurality of flexible electronic displays to display a sequence of images with synchronized transitions between the images.

In some embodiments, the flexible electronic display 100 comprises a wireless interface for communicating with other electronic devices. The wireless interface may enable communication using radio waves, microwaves, infrared signals, ultrasonic signals and/or electromagnetic induction. The wireless interface comprises one or more transceivers configured to communicate over radio, microwave, infrared, ultrasonic, or electromagnetic inductive mediums. The wireless interface may be communicatively coupled to the flexible electronic display 100 and may include circuitry and/or software for communicating with the flexible electronic display 100. In some embodiments, the wireless interface includes a wireless local area network (WLAN) adapter configured to join the flexible electronic display 100 to a WLAN. For example, the wireless interface may be configured host and/or join a WI-FI® hotspot or other wireless network based on the IEEE 802.11 standards. In some embodiments, the wireless interface includes a personal area network (PAN) adapter configured to join the flexible electronic display 100 to a wireless PAN. For example, the wireless interface may be configured to host and/or join a BLUETOOTH® piconet or other wireless network based on the IEEE 802.15.1 or BLUETOOTH® standards. As another example, the wireless interface may be configured to and/or join a Wireless USB™ network. In some embodiments, the wireless interface includes a cellular network adapter configured to communicate data and/or instructions via a cellular telephone network. For example, the wireless interface may comprise a mobile broadband modem capable of communicating over a mobile telephone network (e.g., a 3G or 4G cellular network). In some embodiments, the cellular network adapter supports multiple frequency bands (e.g., a quad-band modem) and is capable of cellular communications in multiple countries. In some embodiments, the wireless interface includes an infrared module configured to communicate data and/or instructions via infrared signals. For example, the wireless interface may be configured to communicate with other infrared devices using the Infrared Data Association (IrDA) protocols.

FIG. 2 illustrates a display stand 200 for use with a flexible electronic display (e.g., flexible electronic display 100) according to certain embodiments of the present disclosure. The display stand 200 comprises a receptacle 202 that holds a flexible electronic display 100, a stabilizer 204, and a support mechanism 206. In some embodiments, the display stand 200 comprises a human-machine interface (HMI) 208 to receive input from a user and/or provide output to a user.

The receptacle 202 is configured to receive a flexible electronic display. For example, the receptacle 202 may be configured to selectively couple with the reel 104 of the flexible electronic display 100. The receptacle 202 may be sized and/or dimensioned to receive the flexible electronic display 100. In some embodiments, the receptacle 202 also couples electrically with the flexible electronic display 100, such that data and/or power may be transferred to the flexible electronic display 100. As the reel 104 of the flexible electronic display 100 may rotate with respect to the receptacle 202 when the flexible electronic display 100 is rolled or unrolled, the electrical coupling may be configured to maintain an electrical connection while the reel 104 rotates with respect to the receptacle 202.

In some embodiments, the receptacle 202 is configured to protect the flexible electronic display 100. For example, the receptacle 202 may be configured to shield the flexible electronic display 100 from the elements or from physical shock while the flexible electronic display 100 is in a retracted (e.g., rolled up) configuration. In some embodiments, the receptacle 202 may be configured to hold more than one flexible electronic display. The receptacle 202 may be further configured to connect electrically to more than one flexible electronic display at a time.

The stabilizer 204 is configured to prevent the display stand 200 from moving after it has been positioned. The stabilizer may comprise one or more feet, stands, anchors, or other suitable stabilizing elements. In some embodiments, the stabilizer 204 is extendable and retractable. For example, one or more feet may swing away from the receptacle 202 to stabilize the display stand 200. As another example, one or more telescoping anchors may extend from the receptacle 202 to stabilize the display stand 202.

The support 206 may comprise one or more support members configured to support a flexible electronic display in an extended (e.g., unfurled) configuration. In some embodiments, the support 206 is extendable. For example, the support 206 may comprise a pair of extendable masts (or poles) for supporting the flexible electronic display 100 in an extended configuration. As another example, the support 206 may comprise a scissors mechanism (i.e., supports linked in a crisscross “X” pattern). The support 206 may comprise hooks or other attachment mechanisms that attach to the flexible electronic display 100 (e.g., to the slat 106). The support 206 may be configured to prevent the display stand from twisting and/or toppling over in windy conditions. For example, the support 206 may comprise an anti-twist mast and/or guy wires.

In certain embodiments, the display stand 200 may deploy the flexible electronic display 100 between a retracted configuration and an extended configuration via an automated or largely automated process. For example, a deployment mechanism (e.g., a deployment mechanism attached to the support 206) may, upon actuation, selectively extend or retract the flexible electronic display 100 via an automated process. The automated or partially automated deployment may be achieved through hydraulic, pneumatic, electrical, or mechanical means.

In certain embodiments, the support 206 may simultaneously support more than one flexible electronic display 100 in an extended configuration. For example, the support 206 may simultaneously support two flexible electronic displays that face opposite directions.

In some embodiments, the display stand 200 comprises a human-machine interface (HMI) 208 to receive input from a user and/or provide output to a user. An HMI 208 enables a user to interact with the flexible electronic display 100, for example, to trigger the displaying of a particular image on the display 100. An HMI 208 may comprise a plurality of buttons and/or keys (e.g., a keyboard), a touch-panel, a voice-recognition system, and/or any other suitable means for receiving user input. An HMI 208 may generate an output capable of being perceived by a user (e.g., a visual and/or audible output). In some embodiments, the HMI 208 may output a user interface (e.g., a graphical user interface) on the flexible electronic display 100. In some embodiments, the HMI 208 may comprise a display (e.g., a display that is smaller than the entire flexible electronic display 100) upon which a user interface (e.g., a graphical user interface) is presented to a user. In some embodiments, the HMI 208 may comprise a speaker for providing audible output. In some embodiments, the HMI is a remote control interface so that a user can control the flexible electronic display 100 via a dedicated remote control or via an external device. For example, the remote control may be an application running on a portable electronic device (e.g., a laptop computer, a tablet computer, a personal data assistant (PDA), or a smartphone).

In some embodiments, the display stand 200 comprises a power source, such as a battery, a capacitor, a generator, or the like. In some embodiments the display stand 200 comprises a power adaptor configured to receive power from a source external to the display stand 200 and to convert the received power into a voltage, amperage, and/or waveform suitable for use by the flexible electronic display 100.

In certain embodiments, the display stand 200 may comprise a computing device suitable for storing images and controlling the flexible electronic display 100 to display an image. The computing device may comprise circuitry, controllers, and/or other computer hardware configured to control the displaying of images on the flexible electronic display 100. The computing device may comprise a data storage medium for storing data representative of images to be displayed on the flexible electronic display 100. In certain embodiments, the display stand 200 comprises an interface for receiving a removable data storage device, such as a USB flash drive or memory card. The display stand 200 may retrieve images stored in the removable data storage device for displaying on the flexible electronic display 100.

FIG. 3 illustrates a flexible display system 300 according to certain embodiments of the present disclosure. The flexible display system 300 comprises a flexible electronic display 100, a display stand comprising a receiver 302, a dock 304, and a support 206.

The receiver 302 is configured to selectively couple with the flexible electronic display 100. For example, the receiver 302 may be configured to couple with the reel 104 of the flexible electronic display 100. The receiver 302 may also be configured to protect the flexible electronic display 100 from the elements and/or from physical shock while the flexible electronic display 100 is in a retracted (e.g., rolled up) configuration. The receiver 302 is also configured to selectively couple with the dock 304. The receiver 302 may be sized and/or dimensioned appropriately to receive and protect the flexible electronic display 100.

The receiver 302 also couples electrically with the flexible electronic display 100, such that data and/or power may be transferred to the flexible electronic display 100 via the receiver 302. As the reel 104 of the flexible electronic display 100 may rotate with respect to the receiver 302 when the flexible electronic display 100 is rolled or unrolled, the electrical coupling may be configured to maintain an electrical connection while the reel 104 rotates with respect to the receiver 302.

The dock 304 is configured to receive the receiver 302 and/or to control the flexible electronic display 100. The dock 304 comprises electrical and, in some embodiments, mechanical connections configured to connect with the receiver 302 (which in turn is connected electrically to the flexible electronic display 100). The dock comprises a computing device 306 for controlling the flexible electronic display 100. The computing device 306 may be configured to store images and control the flexible electronic display 100 to display an image. The computing device may comprise circuitry, controllers, and/or other computer hardware configured to control the displaying of images on the flexible electronic display 100. The computing device may comprise a data storage medium for storing data representative of images to be displayed on the flexible electronic display 100. In certain embodiments, the computing device 306 comprises an interface for receiving a removable data storage device, such as a USB flash drive or memory card. The computing device 306 may retrieve images stored in the removable data storage device for displaying on the flexible electronic display 100.

In some embodiments, the dock 304 further comprises a human-machine interface (HMI) 308 to receive input from a user and/or provide output to a user. The HMI 308 enables the user to interact with the flexible electronic display 100 and may generate an output capable of being perceived by a user (e.g., a visual and/or audible output). The HMI 308 may comprise a plurality of buttons and/or keys (e.g., a keyboard), a touch-panel, a voice-recognition system, and/or any other suitable means for receiving user input. In some embodiments, the HMI 208 may comprise a display (e.g., a display that is smaller than the entire flexible electronic display 102) upon which a user interface (e.g., a graphical user interface) is presented to a user. In some embodiments, the HMI 208 may output a user interface (e.g., a graphical user interface) on the flexible electronic display 100. In some embodiments, the HMI 208 may comprise a speaker for providing audible output. In some embodiments, the HMI is a remote control interface so that a user can control the flexible display system 300 via a dedicated remote control or via an external device. For example, the remote control may be an application running on a portable electronic device (e.g., a laptop computer, a tablet computer, a personal data assistant (PDA), or a smartphone).

In some embodiments, the dock 304 may comprise one or more stabilizers 204 such as feet, legs, or stands. In some embodiments, the dock 304 may comprise wheels and/or handles to aid in transportation.

The support 206 may attach to the dock 304 and may comprise one or more support members configured to support a flexible electronic display in an extended (e.g., unfurled) configuration. The support 206 may comprise a pair of extendable masts (or poles) comprising attachment hooks for supporting the flexible electronic display 100 in an extended configuration as illustrated.

In certain embodiments, the flexible display system 300 may deploy the flexible electronic display 100 between a retracted configuration and an extended configuration via an automated or semi-automated process. For example, a deployment mechanism (e.g., a deployment mechanism attached to the support 206) may, upon actuation, selectively extend or retract the flexible electronic display 100 via an automated process. The automated or partially automated deployment may be achieved through hydraulic, pneumatic, electrical, or mechanical means. In certain embodiments, the automated or semi-automated deployment is triggered via the HMI 308. In certain embodiments, the automated or semi-automated deployment is triggered via remote command.

In some embodiments, the display stand 200 comprises a power source, such as a battery, a capacitor, a generator, or the like. In some embodiments the display stand 200 comprises a power adaptor configured to receive power from a source external to the display stand 200 and to convert the received power into a voltage, amperage, and/or waveform suitable for use by the flexible electronic display 100.

In certain embodiments, the flexible display system 300 may connect to an external computer device to receive image data and/or instructions. The flexible display system 300 may connect to the external computer device via a physical port located in the dock 304 or it may connect via a wireless interface (e.g., a WI-FI® or BLUETOOTH® adapter).

In some embodiments, the flexible display system 300 comprises a wireless interface for communicating with other electronic devices. The wireless interface may enable communication using radio waves, microwaves, infrared signals, ultrasonic signals and/or electromagnetic induction. The wireless interface comprises one or more transceivers configured to communicate over radio, microwave, infrared, ultrasonic, or electromagnetic inductive mediums. The wireless interface may be communicatively coupled to the flexible display system 300 and may include circuitry and/or software for communicating with the flexible display system 300. In some embodiments, the wireless interface includes a wireless local area network (WLAN) adapter configured to join the flexible display system 300 to a WLAN. For example, the wireless interface may be configured host and/or join a WI-FI® hotspot or other wireless network based on the IEEE 802.11 standards. In some embodiments, the wireless interface includes a personal area network (PAN) adapter configured to join the flexible display system 300 to a wireless PAN. For example, the wireless interface may be configured to host and/or join a BLUETOOTH® piconet or other wireless network based on the IEEE 802.15.1 or BLUETOOTH® standards. As another example, the wireless interface may be configured to and/or join a Wireless USB™ network. In some embodiments, the wireless interface includes a cellular network adapter configured to communicate data and/or instructions via a cellular telephone network. For example, the wireless interface may comprise a mobile broadband modem capable of communicating over a mobile telephone network (e.g., a 3G or 4G cellular network). In some embodiments, the cellular network adapter supports multiple frequency bands (e.g., a quad-band modem) and is capable of cellular communications in multiple countries. In some embodiments, the wireless interface includes an infrared module configured to communicate data and/or instructions via infrared signals. For example, the wireless interface may be configured to communicate with other infrared devices using the Infrared Data Association (IrDA) protocols.

In certain embodiments, the flexible display system 300 may synchronize with other electronic displays to display the same image or a complimentary image. For example, the flexible display system 300 may communicate with a plurality of flexible electronic displays to display a sequence of images with synchronized transitions between the images.

FIG. 4 illustrates a flexible LED display 400 according to certain embodiments of the present disclosure. Flexible LED display 400 comprises a display screen 102, a reel 104, a computing device 402, and an interface port 404. In the illustrated embodiment, the display screen 102 is a flexible, LED-based display screen comprising a plurality of LEDs (or OLEDs) on a flexible medium. In other embodiments, the display screen 102 may be a flexible LCD screen, a flexible electrophoretic screen, or a flexible e-paper screen. The computing device 402 is built into the reel 104 and is connected electrically to the display screen 102 and to the interface port 404. The computing device 402 controls the display screen 102. In particular, the computing device 402 controls the displaying of images on the display screen 102 by sending data signals and/or power to the display screen 102. The computing device may comprise circuitry, controllers, and/or other computer hardware configured to control the displaying of images on the display screen 102. In certain embodiments, the computing device 402 stores images to display on the display screen 102. The computing device may comprise a data storage medium for storing data representative of images to be displayed on the display screen 102. In certain embodiments, the computing device 402 may retrieve images stored on a removable data storage device via the interface port 404.

The interface port 404 is built into the exterior of the reel 104 and connects the computing device 402 to devices external to the flexible LED display 400. The external devices may include, but are not limited to, an external computer (e.g., a laptop, tablet computer, smartphone, personal digital assistant (PDA), or the like), an external memory device (e.g., a USB flash drive, a memory card, or the like), a power source (e.g., a battery, a capacitor, a solar panel, or the like), a power adapter, a human machine interface (HMI) for receiving user inputs, and a wireless transceiver.

In some embodiments, the flexible LED display 400 further comprises a power supply 406 and a power supply port 408. The power supply 406 functions to provide power to the display 102 and/or to the computing device 402. In certain embodiments, the power supply 406 may comprise a power source, such as a power generator or a rechargeable energy storage medium (e.g., a battery or a capacitor). The rechargeable energy storage medium may be charged (i.e., store power received) via the power supply port 408. In certain embodiments, the power supply 406 comprises a power adapter configured to adapt power received via the power supply port 408 into a voltage, amperage, and/or waveform suitable for use by the display screen 102 and/or the computing device 402.

FIG. 5 illustrates a computer device 500 for controlling a flexible electronic display (e.g., flexible electronic display 100) according to certain embodiments of the present disclosure. Computer device 500 comprises a microcontroller 502, an interface 504, and a display driver 506. In some embodiments, computer device 500 comprises a power source 508. In other embodiments, the computer device 500 receives power via interface 504. Computer device 500 may be a part of a flexible electronic display (e.g., flexible LED display 400) or may be external to, yet connected to, a flexible electronic display (e.g., a part of display stand 200).

The microcontroller 502 may be any processor suitable for controlling computer device 500. The microcontroller is configured to control the displaying of images on an electronic display, such as display 102. In some embodiments, the microcontroller 502 may receive images and/or instructions via interface 504.

The interface 504 is configured to pass instructions and/or data to computer device 500 from an external device. In some embodiments, the computer device 500 receives power via interface 504. The interface 504 may be configured to receive data from an external computer (e.g., a laptop, tablet computer, smartphone, personal digital assistant (PDA), or the like) and/or from an external memory device (e.g., a USB drive, a memory card, or the like).

The display driver 506 causes images received from the microcontroller 502 to be displayed on the display 102. The display driver comprises hardware and/or software necessary for driving the display 102. In some embodiments, the display driver 506 is a portion of the microcontroller 502. In some embodiments, the display driver 506 is co-located with microcontroller 502.

The power source 508 functions to provide power to the computer device 500. In some embodiments, the power source also provides power to the display 102. In certain embodiments, power source 508 may comprise an energy storage medium (e.g., a battery or a capacitor). The energy storage medium may store power received through the interface 504 or through any other suitable port or interface. In certain embodiments, the power source 508 comprises a power adapter configured to adapt power received from an external source to a type (i.e., voltage, current, and/or waveform) useable by the computer device 500. Although the power source 508 is illustrated as being a part of the computer device 500, in some embodiments the power source 508 is external to the computer device 500.

In some embodiments, the computer device 500 further comprises one or more of: a computer-readable memory 510, a human-machine interface (HMI) 512, and a wireless interface 514. Computer-readable memory 510 is a computer-readable storage medium used to store data, for example images or user preferences, and instructions (e.g., computer programs, operating systems, applications, software, and the like) which may be executed by a processor, such as the microcontroller 502. In some embodiments, computer-readable memory 510 is embedded in the computer device 500. In some embodiments, computer readable memory is a removable storage medium (e.g., a USB drive, a memory card, or the like). Computer-readable memory 510 may comprise volatile and/or non-volatile memory. Examples of computer-readable memory 510 include, but are not limited to, a hard-disk drive (HDD), a solid-state drive (SSD), Read Only Memory (ROM), mask ROM, programmable ROM (PROM), erasable PROM (EPROM), electronically erasable PROM (EEPROM), flash memory, solid state memory, random access memory (RAM), dynamic RAM (DRAM), static RAM (SRAM), or non-volatile RAM (NVRAM). A person of skill in the art would recognize that computer memory 510 may comprise any known form of computer storage or any form of computer storage discovered in the future. Although the computer-readable memory 510 is illustrated as being a part of the computer device 500, in some embodiments the computer-readable memory 510 is external to the computer device 500. For example, the computer-readable memory 510 may be located on an electronic display (e.g., flexible electronic display 100) or a display stand (e.g., display stand 200) and be connected electrically to the microcontroller 502.

The HMI 512 allows a user to interact with the computer device 500. The HMI 512 receives user input and generates output capable of being perceived by a user (e.g., visual and/or audible output). In some embodiments, HMI 512 operates in conjunction with display driver 506 to output a user interface (e.g., a graphical user interface) on display 102. In some embodiments, HMI 512 comprises a display (e.g., a display that is smaller than the entire display 102) upon which a user interface (e.g., a graphical user interface) is presented to a user. HMI 512 may comprise a plurality of buttons and/or keys (e.g., a keyboard), a touch-panel, a voice-recognition system, and/or any other suitable means for receiving user input. In some embodiments, the HMI 512 may further comprise a speaker for providing audible output. Although the HMI 512 is illustrated as being a part of the computer device 500, in some embodiments the HMI 512 is external to the computer device 500. For example, the HMI 512 may be located on an electronic display (e.g., flexible electronic display 100) or a display stand (e.g., display stand 200) and be connected electrically to the microcontroller 502 to allow user interaction with the computer device 500. In some embodiments, the HMI 512 is a remote control interface so that a user can control the flexible LED display via a dedicated remote control or via an external device. For example, the remote control may be an application running on a portable electronic device (e.g., a laptop computer, a tablet computer, a personal data assistant (PDA), or a smartphone).

Wireless interface 514 allows the computer device 500 to communicate wirelessly. In some embodiments, computer device 500 may use wireless interface 514 to communicate with other computer devices (e.g., laptops, tablet computers, smartphones, PDAs, or the like). As an example, computer device 500 may receive data or programming from an external computer via wireless interface 514. As another example, computer device 500 may coordinate the displaying of certain images with other nearby computer devices via wireless interface 514. In some embodiments, computer device 500 may use wireless interface 514 to communicate with a remote controller. In some embodiments, computer device 500 may use wireless interface 514 to connect to a wireless network (e.g., a cellular telephone network or Wi-Fi® hotspot).

The wireless interface 514 comprises one or more transceivers configured to communicate using electromagnetic waves (e.g., radio, microwave, or infrared), acoustic waves (e.g., ultrasound), electromagnetic induction, or any other suitable wireless communication medium. The wireless interface 514 is communicatively coupled to the microcontroller 502 and may include circuitry and/or software for communicating with a flexible electronic display. In some embodiments, the wireless interface 514 includes a wireless local area network (WLAN) adapter configured to form or join a WLAN. For example, the wireless interface 514 may be configured host and/or join a WI-FI® hotspot or other wireless network based on the IEEE 802.11 standards. In some embodiments, the wireless interface 514 includes a personal area network (PAN) adapter configured to form or join a wireless PAN. For example, the wireless interface 514 may be configured to host and/or join a BLUETOOTH® piconet or other wireless network based on the IEEE 802.15.1 or BLUETOOTH® standards. As another example, the wireless interface 514 may be configured to and/or join a Wireless USB™ network. In some embodiments, the wireless interface 514 includes a cellular network adapter configured to communicate data and/or instructions via a cellular telephone network. For example, the wireless interface 514 may comprise a mobile broadband modem capable of communicating over a mobile telephone network (e.g., a 3G or 4G cellular network). In some embodiments, the cellular network adapter supports multiple frequency bands (e.g., a quad-band modem) and is capable of cellular communications in multiple countries. In some embodiments, the wireless interface 514 includes an infrared module configured to communicate data and/or instructions via infrared signals. For example, the wireless interface 514 may be configured to communicate with other infrared devices using the Infrared Data Association (IrDA) protocols.

FIGS. 6A-6B illustrate a rolling stand 600 for use with a flexible electronic display (e.g., flexible electronic display 100) according to certain embodiment of the present disclosure. Rolling stand 600 comprises a body 602, one or more sets of wheels 604, and a handle 606. The body 602 is configured to hold a flexible electronic display. In certain embodiments, the body 602 is a display stand, similar to display stand 200. In certain embodiments, the body 602 is a docking station, similar to dock 304. The body 602 may comprise stabilizing elements (e.g., feet, legs, or stands similar to stabilizer 204) and/or display support elements (e.g., masts, poles, or scissor mechanisms similar to support 206). In certain embodiments, the body 602 is electrically connected to the flexible electronic display and sends data and/or power to the flexible electronic display. In certain embodiments, the body 602 controls the displaying of images on the flexible electronic display. In certain embodiments, the body 602 comprises a power source that provides power to the flexible electronic display.

The wheels 604 allow the rolling stand 600 to be easily transported. The wheels 604 may be constructed from any suitable material, including metal, wood, rubber, plastic, polymer, etc. The wheels 604 may be constructed from a combination of different material, e.g., a rubber tire on a polymer rim. In some embodiments, the wheels 604 may retract into the body 602 so that the rolling stand 600 stays in place. In some embodiments, the wheels 604 may lock so that the rolling stand 600 stays in place.

FIG. 6A shows one embodiment of a rolling stand 600 comprising two sets of wheels 604 and a handle 606. The rolling stand is easily transported by pulling on the handle 606. The two sets of wheels 604 allow the body 602 to remain substantially parallel to the ground. When the rolling case 600 has been transported to the desired location, the wheels 604 may retract into the body 602 or may be locked. In some embodiments, one or more stabilizing elements of the body 602 may extend to the ground to prevent the rolling stand 600 from moving.

FIG. 6B shows one embodiment of a rolling stand 600 comprising one set of wheels 604 and a handle 606. The rolling stand is easily transported by pivoting the rolling stand 600 off the ground (but resting on the wheels 604) and pulling on the handle 606. When the rolling case 600 has been transported to the desired location, the wheels 604 may retract into the body 602 or may be locked. In some embodiments, one or more stabilizing elements of the body 602 may extend to the ground to prevent the rolling stand 600 from moving.

It will be obvious to those having skill in the art that many changes may be made to the details of the above-described embodiments without departing from the underlying principles of the invention.

1. An electronic display assembly comprising:
a reel; and
a flexible electronic display screen configured to display images and coupled to the reel, the flexible electronic display screen disposed around the reel in a retracted configuration and the majority of the flexible electronic display screen extending from the reel in an extended configuration.

2. The electronic display assembly of claim 1, wherein the flexible electronic display screen is electrically coupled to the reel.

3. The electronic display assembly of claim 1, wherein the flexible electronic display screen comprises one or more of a light-emitting diode, an organic light-emitting diode, a liquid crystal display element, and an electronic paper pixel.

4. The electronic display assembly of claim 1, wherein the flexible electronic display screen comprises a human-machine interface configured to receive user input.

5. The electronic display assembly of claim 1, wherein the flexible electronic display screen comprises an interface configured to connect to one or more of an external computer and a removable data storage device.

6. The electronic display assembly of claim 1, further comprising a computing device electrically coupled to the flexible electronic display screen and configured to control the images displayed on the flexible electronic display screen.

7. The electronic display assembly of claim 1, further comprising an elongate shaft coupled to an end of the flexible electronic display screen; and
a handle coupled to the elongate shaft and configured to enable a user to transition the flexible electronic display screen from the retracted configuration to the extended configuration by application of manual force to the handle.

8. The electronic display assembly of claim 1, further comprising an electronic display stand configured to support the reel and the flexible electronic display screen.

9. The electronic display assembly of claim 8, wherein the electronic display stand comprises a power source configured to power the flexible electronic display screen.

10. The electronic display assembly of claim 8, wherein the electronic display stand comprises a human-machine interface to receive user input and control the flexible electronic display screen.

11. The electronic display assembly of claim 8, wherein the electronic display stand comprises a docking connector configured to electrically connect to the flexible electronic display screen.

12. The electronic display assembly of claim 8, wherein the electronic display stand comprises one or more supports configured to hold the flexible electronic display screen in the extended configuration.

13. The electronic display assembly of claim 8, wherein the electronic display stand is configured to simultaneously support more than one flexible electronic display screen.

14. The electronic display assembly of claim 8, wherein the electronic display stand comprises a wheel and a handle to facilitate transport.

15. An electronic display system, comprising:
a reel;
a flexible electronic display configured to display dynamic images and coupled to the reel, the flexible electronic display disposed around the reel in a retracted configuration and the majority of the flexible electronic display extending from the reel in an extended configuration;
a docking connector electrically coupled to the flexible electronic display;
a computing device electrically coupled to the flexible electronic display to control the dynamic images displayed on the flexible electronic display; and
an electronic display stand coupled to the reel and supporting the flexible electronic display in both the extended and retracted configurations.

16. The electronic display system of claim 15, further comprising a human-machine interface in electrical communication with the computing device to receive user input.

17. The electronic display assembly of claim 15, wherein the flexible electronic display comprises one or more of a light-emitting diode, an organic light-emitting diode, a liquid crystal display element, and an electronic paper pixel.

18. The electronic display system of claim 15, wherein the electronic display stand comprises a receptacle including a receiver and a dock, wherein the receiver is configured to selectively couple to the reel and the dock is configured to receive the receiver.

19. The electronic display system of claim 19, further comprising one or more supports configured to hold the flexible electronic display in an extended configuration.

21. The electronic display system of claim 20, wherein the one or more supports are coupled to the receptacle.

23. The electronic display system of claim 15, wherein the electronic display stand is configured to simultaneously support two or more flexible electronic displays.

24. The electronic display system of claim 15, further comprising an interface in electrical communication with the computing device to receive a removable data storage device.
